(19) United States
(12) Patent Application Publication
(10) Pub. No.: US 2026/0358179 A1
(43) Pub. Date: Nov. 12, 2026

(54) TEMPERATURE SENSOR ELEMENT AND TEMPERATURE SENSOR

(71) Applicant: SHIBAURA ELECTRONICS CO., LTD., Saitama-shi, Saitama (JP)

(72) Inventor: Naohiro NIIZEKI, Saitama-shi, Saitama (JP)

(21) Appl. No.: 18/840,371

(22) PCT Filed: Nov. 6, 2023
(86) PCT No.: PCT/JP2023/039829

§ 371 Date: Jul. 24, 2026

(51) Int. Cl. G01K 7/22

(52) U.S. Cl. CPC G01K 7/22

(57) ABSTRACT

A temperature sensor element includes: a heat-sensitive body having an electric resistance that is variable with temperature; a first coating layer that covers a periphery of the heat-sensitive body; a pair of lead-out wires that are connected to the heat-sensitive body and also are led out in penetration through the first coating layer, toward a rear end side; a second coating layer that covers peripheries of the pair of lead-out wires that are led out in penetration through the first coating layer; and a third coating layer that covers peripheries of the first coating layer and the second coating layer. When linear expansion coefficients of the lead-out wire, the second coating layer and the third coating layer are represented by α15, α25 and α30, respectively, a relationship of α15<α<α25 holds.

### TECHNICAL FIELD

The present invention relates to a temperature sensor element that includes a heat-sensitive body, such as a thermistor, having an electrical characteristic that is variable in response to a temperature change.

### BACKGROUND ART

A temperature sensor element includes: for example, a thermistor that is formed of a sintered body of an electroconductive oxide; a coating layer covering a periphery of the thermistor; and a pair of lead-out wires that are connected to the thermistor and are led out in penetration through the coating layer.

The coating layer is used for improving a mechanical and thermal durability of the thermistor, and for preventing a foreign matter that may lower the performance of the temperature sensor element from entering a thermistor portion from outside.

The temperature sensor element tends to be more easily affected by an atmospheric temperature in a high temperature state than in a low temperature state, and accordingly, needs to use also a coating layer that is stable in the high temperature state. As the coating material for high temperature, a coating material formed from glass can be used when the temperature is up to 800 °C, but the glass cannot be used at a higher temperature, for example, at a temperature of 900 °C or higher.

In order to solve the aforementioned problems, Patent Literature 1 proposes a thermistor element that is configured to join lead wires to both upper and lower surfaces of a thermistor chip, respectively, in which electrodes are formed on both the aforementioned surfaces of a planar sintered body, respectively, that is composed of a combination of a plurality of metal oxides and a sintering accelerator having an electroconductivity enhancing action. In this proposal, it is described that the thermistor can be provided which can withstand high temperature, by coating a portion of a thermistor chip with a coating material composed of the aforementioned plurality of metal oxides having a material ratio substantially equal to that of the aforementioned combination and a sintering accelerator that does not have the electroconductivity enhancing action, and firing the resultant coating material.

### CITATION LIST

### Patent Literature

Patent Literature 1: JP 2006-54258 A

### SUMMARY OF INVENTION

### Technical Problem

However, it has been found that when the thermistor element disclosed in Patent Literature 1 has been continuously used for a long time in a high-temperature atmosphere of, for example, 900 °C or higher, an electric resistance value changes, and desired performance cannot be maintained. In the thermistor element disclosed in Patent Literature 1, materials of the thermistor chip, the coating layer and the lead wire are different from each other, and accordingly, linear expansion coefficients are also different from each other. According to the knowledge of the inventors, because the linear expansion coefficients are different from each other, when the thermistor element is exposed to a high-temperature atmosphere for a long time, a gap may be formed between the lead wire and the protective layer, and moisture or the like present in the air is evaporated or the like in the high-temperature atmosphere to generate a reducing gas. The reducing gas enters the thermistor chip through an interface between the coating layer and the lead-out wire. The thermistor is an oxide, and accordingly, it is assumed that the thermistor is reduced by the reducing gas that has entered the thermistor, and an accuracy of temperature detection as the temperature sensor element lowers in some cases.

Thus, an object of the present invention is to provide a temperature sensor element that can suppress a reduction reaction of a heat-sensitive body even after continuous use in a strong reducing atmosphere for a long time, by reducing a gap at an interface between the lead-out wire and the coating layer surrounding the lead-out wire.

### Solution to Problem

The present invention includes: a heat-sensitive body having an electrical resistance that is variable with temperature; a first coating layer that covers a periphery of the heat-sensitive body; a pair of lead-out wires that are connected to the heat-sensitive body and are led out in penetration through the first coating layer toward a rear end side; a second coating layer that covers peripheries of the pair of lead-out wires that are led out in penetration through the first coating layer; and a third coating layer that covers peripheries of the first coating layer and the second coating layer.

In the present invention, when linear expansion coefficients of the lead-out wire, the second coating layer and the third coating layer are represented by α15, α25, and α30, respectively, the relationship of α15<α30<α25 holds.

Furthermore, in the present invention, it is preferable that the first coating layer include a first oxide powder or a mixture of the first oxide powder and glass, that the second coating layer include a mixture of a second oxide powder and glass, and that the third coating layer include a mixture of a third oxide powder and glass.

In addition, when the linear expansion coefficients of the first oxide powder, the second oxide powder and the third oxide powder are represented by β20, β25 and β30, respectively, a relationship of β20<β30<β25 holds.

Furthermore, in the present invention, it is preferable that the first oxide powder be formed of a powder of a thermistor, as included in the heat-sensitive body, and that the second oxide powder be formed of a powder of one or more types of ZrO₂, CaO and MgO.

Furthermore, in the present invention, it is preferable that the second coating layer cover peripheries of the pair of lead-out wires that are led out in penetration through the first coating layer, and also cover the first coating layer between the first coating layer and the third coating layer.

Furthermore, in the present invention, it is preferable that the second coating layer limitedly cover the peripheries of the pair of lead-out wires which are led out in penetration through the first coating layer, and that the first coating layer and the third coating layer come in direct contact with each other.

Furthermore, in the present invention, it is preferable that when a thickness of the second coating layer and a thickness of the third coating layer be represented by t25 and t30, respectively, a relationship of t25<t30 holds.

Furthermore, in the present invention, it is preferable in the first coating layer that the first oxide powder be added with claim 1 of P1804.

Furthermore, according to the present invention, a temperature sensor is provided that includes the temperature sensor element described above.

### Advantageous Effects of Invention

In the present invention, when the linear expansion coefficients of the lead-out wire, the second coating layer and the third coating layer are represented by α15, α25, and α30, respectively, the relationship of α15<α30<α25 holds. When this relationship holds, the gap at the interface is reduced between the lead-out wire and the first coating layer that surrounds the lead-out wire, and thereby, even after the heat-sensitive body is continuously used in a strong reducing atmosphere for a long time, a reduction reaction of the heat-sensitive body is suppressed.

### BRIEF DESCRIPTION OF DRAWINGS

FIG. 1 shows a longitudinal cross-sectional view showing a schematic configuration of a temperature sensor element according to a first embodiment.

FIG. 2A shows a cross-sectional view around a lead-out wire 15 in FIG. 1, and FIG. 2B shows a schematic view showing expansions of the lead-out wire, an intermediate layer and an outer layer coating of the thermistor element in FIG. 1.

FIG. 3 shows a flow chart showing a procedure for manufacturing the temperature sensor element according to the first embodiment.

FIG. 4A and FIG. 4B each show a view showing a procedure for manufacturing the temperature sensor element according to the first embodiment.

FIG. 5A and FIG. 5B each shows a view showing a procedure for manufacturing the temperature sensor element according to the first embodiment, which are continued from FIG. 4A and FIG. 4B.

FIG. 6A and FIG. 6B each show a longitudinal cross-sectional view showing a schematic configuration of a temperature sensor element according to a second embodiment.

FIG. 7A and FIG. 7B each show a view showing a procedure for manufacturing the temperature sensor element according to the second embodiment, which are continued from FIG. 4A and FIG. 4B.

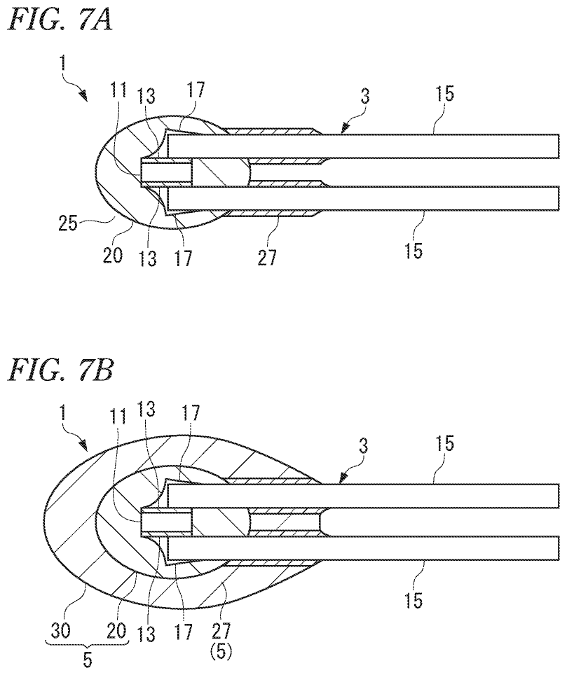

### DESCRIPTION OF EMBODIMENTS

Embodiments of the present invention will be described below with reference to the accompanying drawings.

A temperature sensor element 1 according to one embodiment of the present invention will be described with reference to the drawings.

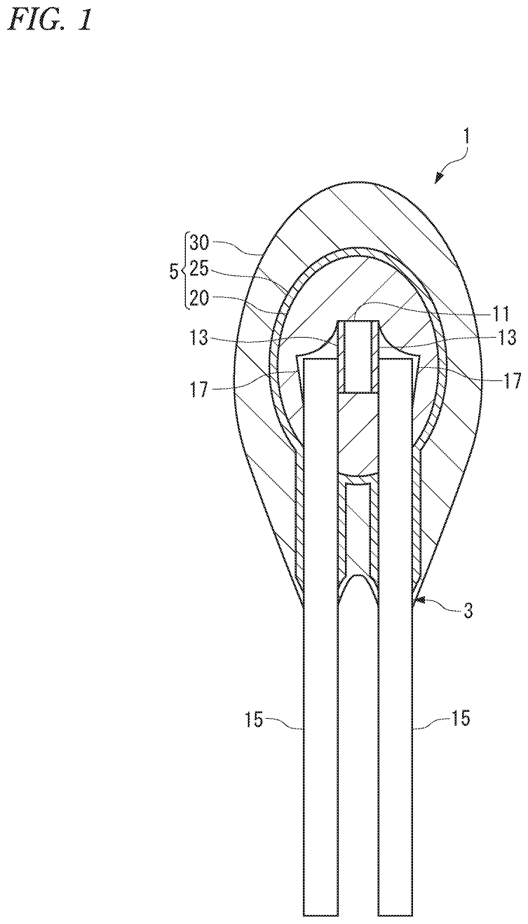

As shown in FIG. 1, the temperature sensor element 1 according to the present embodiment includes a thermistor element 3 and a coating layer 5. The thermistor element 3 includes: a heat-sensitive body 11 having an electric characteristic, such as an electric resistance value, that is variable with temperature; a pair of electrodes 13 and 13 which are formed on front and rear surfaces facing each other of the heat-sensitive body 11, respectively; a pair of lead-out wires 15 and 15 which are connected to the electrodes 13 and 13, respectively; and connection electrodes 17 and 17 which electrically connect the electrodes 13 and 13 with the lead-out wires 15 and 15. In addition, the coating layer 5 includes: a first coating layer 20 that covers the heat-sensitive body 11 and a part of the lead-out wires 15 and 15 together; a third coating layer 30 that covers the outside of the first coating layer 20; and a second coating layer 25 that is interposed between the first coating layer 20 and the third coating layer 30.

The temperature sensor element 1 is provided with the second coating layer 25 between the first coating layer 20 and the third coating layer 30, and the second coating layer 25 is made to have a tightening effect which will be described in detail later. The temperature sensor element 1 can reduce a rate of change in the electric resistance value of the heat-sensitive body 11 to a small value, in a high-temperature reducing atmosphere, for example, an atmosphere containing hydrogen.

Note that in some cases, the temperature sensor element 1 may form a temperature sensor in a state of being accommodated in a protective pipe made from a metal excellent in heat resistance and oxidation resistance, such as stainless steel or Ni superalloy, though the specific description will be omitted here.

Hereinafter, each element of the temperature sensor element 1 will be described, and then an operation and effects of the temperature sensor element 1 will be described.

### Heat-Sensitive Body 11

A thermistor sintered body is suitably used for the heat-sensitive body 11. A thermistor is an abbreviation of a thermally sensitive resistor, and is a metal oxide that measures a temperature by utilizing its property that an electric resistance value changes according to a temperature.

The thermistor is classified into a negative temperature coefficient (NTC) thermistor and a positive temperature coefficient (PTC) thermistor, and any of the thermistors can be used in the present invention.

An oxide sintered body can be used for the heat-sensitive body 11, which includes manganese oxide (Mn₃O₄) that has a spinel structure which is typical for an NTC thermistor, as a basic composition. The oxide sintered body can be used for the heat-sensitive body 11, which has a composition of M×Mn₃₋ₓO₄ that is obtained by addition of an M element (one or more of Ni, Co, Fe, Cu, Al and Cr) to the basic composition. Furthermore, one or more of V, B, Ba, Bi, Ca, La, Sb, Sr, Ti and Zr can be added.

In addition, the oxide sintered body can be used for the heat-sensitive body 11, which includes a composite oxide having a perovskite structure that is typical for an NTC thermistor, for example, YCrO₃, as a basic composition. The sintered body is most typical as the NTC thermistor, which includes a Y₂O₃ phase and at least one of a Y(Cr, Mn)O₃ phase, a YCrO₃ phase and a YMnO₃ phase.

### Method for Manufacturing Thermistor Sintered Body

The heat-sensitive body 11 formed of the thermistor sintered body is manufactured through the steps of: weighing raw material powders; mixing the raw material powders; drying the raw material powders; calcining; mixing and pulverizing after the calcining; drying and granulating; and compacting and sintering. Each step will be described below while using a thermistor sintered body having the Y₂O₃ phase and the Y(Cr, Mn)O₃ phase, as an example.

### Weighing of Raw Material Powder

Raw material powders containing yttrium oxide (Y₂O₃) powder, chromium oxide (Cr₂O₃) powder, manganese oxide (MnO, Mn₂O₃, Mn₃O₄ or the like) powder and calcium carbonate (CaCO₃) powder are weighed so as to form the aforementioned chemical composition.

Note that in the present embodiment, the powder is composed of a plurality of particles.

The Y₂O₃ powder contributes to the formation of a Y₂O₃ phase; and the Y₂O₃ powder, the Cr₂O₃ powder and the manganese oxide powder (Mn₃O₄ powder) contribute to the formation of a Y(Cr, Mn)O₃ phase. The CaCO₃ powder functions as a sintering aid, and in addition, contributes to the lowering of the B constant, by dissolving in the Y(Cr, Mn)O₃ phase in a form of Ca.

As for the raw material powders, powders are used that have a purity of 98% or higher, preferably 99% or higher, and more preferably 99.9% or higher, in order to obtain a thermistor sintered body having high characteristics.

The particle size of the raw material powder is not limited as long as the calcination proceeds, but can be selected in a range of 0.1 to 6.0 μm by a particle size (d50).

### Mixing of Raw Material Powders and Ball Mill

The Y₂O₃ powder, the Cr₂O₃ powder, the Mn₃O₄ powder and the CaCO₃ powder which have been weighed by predetermined amounts are mixed. The mixing can be performed, for example, by adding water to the mixed powder into a slurry state, and mixing the slurry by a ball mill. For the mixing, a mixer other than a ball mill can also be used.

### Drying of Raw Material Powder

It is preferable to dry and granulate the slurry after the mixture, with a spray dryer or other equipment, and to form a mixed powder for calcination.

### Calcination

The mixed powder for calcination after drying is calcined. By the calcination, a calcined body having a composite structure of the Y₂O₃ phase and the Y(Cr, Mn)O₃ phase is obtained from the Y₂O₃ powder, the Cr₂O₃ powder, the Mn₃O₄ powder and the CaCO₃ powder.

The calcination is performed by, for example, charging the mixed powder for calcination into a crucible, and holding the mixed powder in a temperature range of 800 to 1300 °C in the air. If the calcination temperature is lower than 800 °C, the formation of the composite structure is insufficient, and if the calcining temperature exceeds 1300 °C, there is a possibility that the sintering density decreases and the stability of the resistance value decreases. For this reason, the holding temperature for calcination is set in a range of 800 to 1300 °C.

The holding time period in the calcination should be appropriately set according to the holding temperature, but when the holding temperature is in the aforementioned temperature range, the purpose of the calcination can be achieved by a holding time period of approximately 0.5 to 100 hours.

### Mixing, Pulverization and Ball Mill

The powder after the calcination is mixed and pulverized. The mixing and pulverization can be performed by adding water to form a slurry and using a ball mill, as in the case before the calcination.

### Drying and Granulation

It is preferable to dry and granulate the powder after the pulverization, by a spray dryer or other equipment.

### Compaction

The granulated powder after the calcination is compacted into a predetermined shape.

For compaction, press compacting with the use of a die, and besides a cold isostatic press (Cold Isostatic Press: CIP) can be used.

As the density of the compacted body is higher, it is easier to obtain a sintered body with higher density; and accordingly, it is desirable to increase the density of the compacted body as much as possible. For that purpose, it is preferable to use CIP with which the high density can be obtained.

### Sintering

Next, the obtained compacted body is sintered.

The sintering is performed by holding the compacted body in a temperature range of 1400 to 1650°C in the air. If the sintering temperature is lower than 1400 °C, the formation of the composite structure is insufficient; and if the sintering temperature exceeds 1650 °C, the sintered body melts, and/or a reaction occurs with a crucible for sintering and/or the like. The holding time period in the sintering should be appropriately set according to the holding temperature, but when the holding temperature is in the aforementioned temperature range, a dense sintered body can be obtained by a holding time period of approximately 0.5 to 200 hours.

It is preferable to subject the obtained thermistor sintered body to annealing, in order to stabilize the characteristics of the thermistor. The annealing is performed by holding the obtained thermistor sintered body, for example, at 1000 °C in the atmosphere.

### Electrodes 13 and 13 and Connection Electrodes 17 and 17

As shown in FIG. 1, the electrodes 13 and 13 are formed in a film shape on the whole areas of both top and bottom surfaces of the heat-sensitive body 11 having a plate shape, respectively. The electrodes 13 and 13 are formed, for example, from platinum (Pt) or another noble metal.

The electrodes 13 and 13 are formed as a thick film or a thin film. The thick film electrodes 13 and 13 are formed by applying a paste which has been produced by mixing an organic binder with a platinum powder, onto both of the top and bottom surfaces of the thermistor sintered body, and by drying and then sintering the paste. In addition, the thin film electrode can be formed by vacuum deposition or sputtering.

The heat-sensitive body 11 on which the electrodes 13 and 13 are formed is worked into a predetermined dimension.

The connection electrodes 17 and 17 are composed of metal films which are formed on the surfaces of the electrodes 13 and 13, respectively. The connection electrodes 17 and 17 are also formed preferably from platinum (Pt) or another noble metal.

### Lead-Out Wires 15 and 15

As shown in FIG. 1, one end side of each of the lead-out wires 15 and 15 is electrically and mechanically connected to the corresponding electrode 13 or 13 via the corresponding connection electrode 17 or 17. The other end sides of the lead-out wires 15 and 15 are connected to an unillustrated external detection circuit. The lead-out wires 15 and 15 are composed of a wire material which has heat resistance and is formed from, for example, platinum or an alloy of platinum and iridium (Ir).

The lead-out wires 15 and 15 are connected to the electrodes 13 and 13, in the following way.

A paste containing platinum powder which will form the connection electrodes 17 and 17 is applied to each one end side of the lead-out wires 15 and 15 beforehand. The platinum paste is dried in a state in which the respective sides of the lead-out wires 15 and 15, on which the platinum paste has been applied, are brought into contact with the electrodes 13 and 13, and then the platinum powder is sintered.

### First Coating Layer 20

Next, the first coating layer 20 will be described.

It is a main function given to the first coating layer 20 to become a buffer material for alleviating a stress generated by thermal expansion of the third coating layer 30, from being directly applied to the heat-sensitive body 11. In other words, the first coating layer 20 receives a thermal stress from the third coating layer 30.

In addition, the first coating layer 20 fixes connection portions between the heat-sensitive body 11 and the lead-out wires 15 and 15, and thereby realizes stable electrical and mechanical connections.

The first coating layer 20 according to the present embodiment includes two preferable forms.

A first form is formed from a mixture of glass and an oxide powder (first oxide powder), and a second form is formed from an aggregate of the first oxide powder. In the first form and the second form, expressions of a second oxide powder and a third oxide powder are used in addition to a first oxide powder, but these expressions are used only for distinguishing the first coating layer 20 from the second coating layer 25 and the third coating layer 30. Accordingly, the same oxide powder may be employed for, for example, the first oxide powder and the third oxide powder.

In the first coating layer 20 of the first form, the glass functions as a binder that binds the oxide powders to each other and allows the first coating layer 20 to maintain its shape.

A ratio of the glass to the oxide powder is not limited as long as the desired linear expansion coefficient is obtained and the glass functions as the binder.

As the glass included in the first coating layer 20, one or both of crystalline glass and amorphous glass can be used, but it is preferable to use crystallized glass which is stable at high temperature. As the crystallized glass, a composition can be employed, which contains, for example, 30 to 60% by weight of silicon oxide (SiO₂), 10 to 30% by weight of calcium oxide (CaO), 5 to 25% by weight of magnesium oxide (MgO), 0 to 15% by weight of aluminum oxide (Al₂O₃), so that the sum of the aforementioned components yields 100% by mass.

Examples of the oxide powders included in the first coating layer 20 include aluminum oxide (Al₂O₃), magnesium oxide (MgO), calcium oxide (CaO), yttrium oxide (Y₂O₃), and zirconium oxide (ZrO₂). In addition, as a preferable form of this oxide powder, a thermistor powder can be used.

As the thermistor powder, a powder can be used which has a composition equivalent to that of the thermistor sintered body included in the heat-sensitive body 11. The equivalent composition means that both of the thermistor powders contained in the heat-sensitive body 11 and in the first inner layer form have the aforementioned chemical composition of Cr, Mn, Ca and Y, excluding 0, which is included in a composition range of Cr: 3 to 15 mol %, Mn: 5 to 15 mol %, and Ca: 0.5 to 8 mol %. The case is also included where the thermistor powder and the thermistor sintered body included in the heat-sensitive body 11 have the same composition.

The second form of the first coating layer 20 is composed of an aggregate of oxide powder (first oxide powder). This first coating layer 20 does not contain glass, and accordingly, has an enhanced function of receiving thermal stress. The first coating layer 20 formed from an aggregate of oxide powder is different from a layer containing glass in an action of receiving the thermal stress. Specifically, the first coating layer 20 according to the first form containing glass receives the thermal stress by securing its rigidity, but the first coating layer 20 formed from the oxide powder containing no glass receives the thermal stress by way of mutual positional displacement of particles included in the oxide powder.

It is difficult for the first coating layer 20 according to the second form, which does not contain glass, to maintain its shape by itself, and accordingly, the third coating layer 30 is solely responsible for maintaining the shape. Specifically, the third coating layer 30 is formed over a periphery of the first coating layer 20 while sandwiching the second coating layer 25 therebetween, and in a state in which an external force is not applied, the third coating layer 30 holds the first coating layer 20, and thereby, the first coating layer 20 can maintain its shape even without containing glass.

In addition, when the third coating layer 30 is fired, there is a portion in which the particles included in the first coating layer 20 are bonded to each other by diffusion of elements between the adjacent particles. This bonded portion can contribute to the maintenance of the first coating layer 20 in addition to the holding by the third coating layer 30. However, the bonding between the adjacent particles is not necessarily strong. In view of the stress relaxation effect of the first coating layer 20, it is rather preferable that the bonding between adjacent particles be weak.

### Third Coating Layer 30

Next, the third coating layer 30 will be described.

It is a main function of the third coating layer 30 to provide airtightness for hermetically sealing of the heat-sensitive body 11 from the surrounding atmosphere. In addition, the third coating layer 30 imparts a mechanical strength for protecting the heat-sensitive body 11 from an external force.

The third coating layer 30 can also be formed from a mixture of glass and oxide powder (third oxide powder) similar to that of the first coating layer 20. A usable oxide powder includes one or more of aluminum oxide (Al₂O₃), magnesium oxide (MgO), yttrium oxide (Y₂O₃), calcium oxide (CaO), zirconium oxide (ZrO₂), strontium oxide (SrO), titanium oxide (TiO) and lanthanum oxide (La₂O₃).

The third coating layer 30 according to the present embodiment is formed from a mixture of glass and oxide powder, which is similar to that of the first coating layer 20. However, the third coating layer 30 contains a large amount of glass, as compared to the first coating layer 20. This is to satisfy the relationship among the linear expansion coefficients, which will be described later.

The third coating layer 30 can obtain a necessary thickness and state by one layer of the third coating layer 30, which is formed by one time of operation, but the third coating layer 30 can also be formed into a plurality of layers. When the third coating layer 30 is formed of a plurality of layers, each layer may have an equal thickness or an unequal thickness.

### Second Coating Layer 25

Next, the second coating layer 25 will be described.

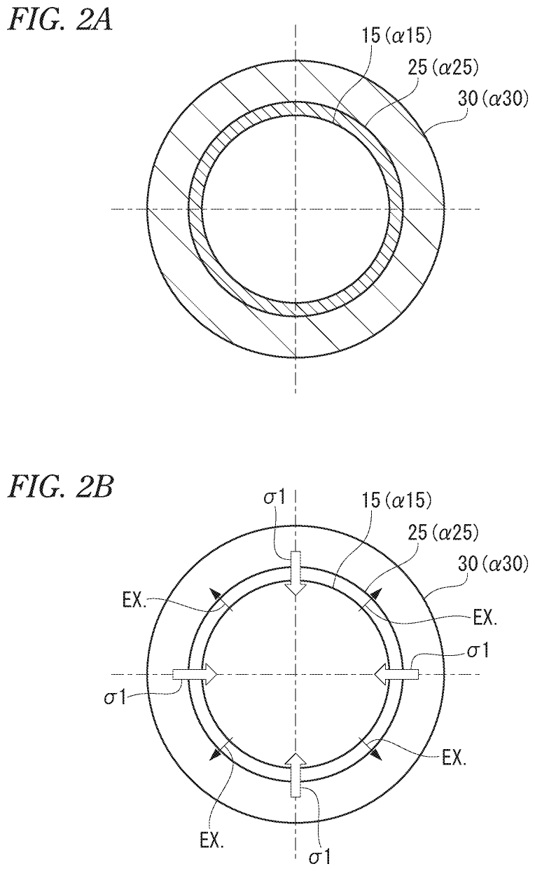

As shown in FIG. 1 and FIG. 2A, the second coating layer 25 is provided between the first coating layer 20 and the third coating layer 30, and covers the first coating layer 20 and the outer peripheral surface of the lead-out wire 15 that is led out from the first coating layer 20. The periphery of the second coating layer 25 that covers the lead-out wire 15 is covered with the third coating layer 30.

It is preferable that the second coating layer 25 be formed from the mixture of glass and oxide powder (second oxide powder) similar to that of the first coating layer 20.

It is understood that the second coating layer 25 applies a compressive stress σ1 to the lead-out wire 15 while the temperature sensor element 1 is used in a high temperature range, and thereby brings the boundary surface between itself and the lead-out wire 15 into close contact. Due to the application of the compressive stress σ1, minute gaps between the lead-out wire 15 and the second coating layer 25 are reduced, and thereby the reduction resistance of the temperature sensor element 1 is enhanced.

### Compressive Stress by Second Coating Layer 25

In some cases, the temperature sensor element 1 is used in a reducing atmosphere containing hydrogen, in a temperature range of, for example, room temperature to 1050 °C. The second coating layer 25 is provided for the purpose of suppressing a reduction reaction of the heat-sensitive body 11 of the temperature sensor element 1 in a reducing atmosphere, in other words, for the purpose of imparting the reduction resistance to the temperature sensor element 1. According to the studies of the present inventors, it is assumed that when the temperature sensor element 1 is used at a high temperature, a compressive stress σ1 acts from the second coating layer 25 toward the lead-out wire 15, and thereby the reduction resistance is imparted by the second coating layer 25. In other words, it is recognized that the compressive stress σ1 is generated by a magnitude relationship among the linear expansion coefficients of the lead-out wire 15, the third coating layer 30 and the second coating layer 25. The description will now be given with reference to FIGS. 2A and 2B.

As for a structure around the second coating layer 25, as shown in FIG. 2A, the second coating layer 25 is in contact with the outer circumferential surface of the lead-out wire 15, and also surrounds the periphery of the lead-out wire 15. When viewed from a side of the lead-out wire 15, the lead-out wire 15, the second coating layer 25 and the third coating layer 30 are arranged in this order.

Next, the relationship among α15, α25 and α30 of the linear expansion coefficients of the lead-out wire 15, the second coating layer 25 and the third coating layer 30 is as shown in the following Expression (1), and the linear expansion coefficient α25 of the second coating layer 25 is the largest among the three factors.

α15<α30<α25 (1)

When the temperature sensor element 1 including the lead-out wire 15, the second coating layer 25 and the third coating layer 30 is exposed to a high-temperature environment, the lead-out wire 15, the second coating layer 25 and the third coating layer 30 tend to expand in a radial direction (D). Because the lead-out wire 15, the second coating layer 25 and the third coating layer 30 have the relationship of the Expression (1), the second coating layer 25 sandwiched between the lead-out wire 15 and the third coating layer 30 is affected by the expansion of the lead-out wire 15 and the third coating layer 30. Then, regarding the relationship between the lead-out wire 15 and the second coating layer 25, the linear expansion coefficient of the second coating layer 25 is larger than that of the lead-out wire 15; and accordingly, the lead-out wire 15 and the second coating layer 25 are not restrained by each other, and expansion EX. toward the outside in the radial direction D occurs in each of the lead-out wire 15 and the second coating layer 25. On the other hand, regarding the relationship between the second coating layer 25 and the third coating layer 30, the linear expansion coefficient of the third coating layer 30 is smaller than that of the second coating layer 25, and the expansion EX. of the second coating layer 25 toward the outside in the radial direction (D) is restrained. As a result, the compressive stress σ1 is generated from the second coating layer 25 toward the inner side in the radial direction (D), with respect to the lead-out wire 15. Due to the compressive stress σ1, a gap is less likely to be formed at the boundary between the lead-out wire 15 and the second coating layer 25, and the lead-out wire 15 and the second coating layer 25 come in firm contact with each other. Thus, according to the temperature sensor element 1 of the first embodiment, it is suppressed that the reducing gas containing hydrogen intrudes from the boundary between the lead-out wire 15 and the second coating layer 25.

To the second coating layer 25 which is considered to produce the aforementioned effect, an oxide powder (second oxide powder) having a large linear expansion coefficient is applied, which is, for example, one or more of ZrO₂ powder, MgO powder and CaO powder. Glass becomes another component of the oxide powder, as in the third coating layer 30.

### Relationship Between Thicknesses of Second Coating Layer 25 and Third Coating Layer 30

When the thickness of the second coating layer 25 is represented by t25 and the thickness of the third coating layer 30 is represented by t30, it is preferable for the layers to have a relationship of t25≤t30, and is more preferable to have a relationship of t25<t30. Within this range, it is preferable that t25 be small, in order to obtain the tightening effect by the second coating layer 25. Specific t25 and t30 are selected from the following ranges. Note that the unit is mm. t25: 0.03 to 0.3, 0.05 to 0.2, and 0.07 to 0.15 t30: 0.20 to 2.0, 0.3 to 1.25, and 0.45 to 1.0

### Compressive Stress σ2 on Heat-Sensitive Body 11

In a process in which the temperature sensor element 1 is exposed to a temperature in a range of, for example, room temperature to 1000 °C, it is preferable to suppress the compressive stress σ2 which is applied to the heat-sensitive body 11, to a low value. This is to suppress a change in the electrical characteristics, particularly the resistance value, of the heat-sensitive body 11.

In order to satisfy this requirement, it is desired to adjust the linear expansion coefficients of the heat-sensitive body 11, the lead-out wires 15, the first coating layer 20 and the third coating layer 30. In other words, it is desired that the linear expansion coefficient α20 of the first coating layer 20 becomes close to the linear expansion coefficient all of the heat-sensitive body 11, and the linear expansion coefficient α30 of the third coating layer 30 becomes close to the linear expansion coefficient α15 of the lead-out wire 15. Specifically, the difference between the linear expansion coefficient α20 and the linear expansion coefficient all and the difference between the linear expansion coefficient α30 and the linear expansion coefficient α15 are preferably controlled to 5×10⁻⁷/K or less, and are more preferably controlled to 3×10⁻⁷/K or less.

The linear expansion coefficients of the thermistor sintered body included in the heat-sensitive body 11, platinum included in the lead-out wire 15, for example, and various oxides at 25 to 900 °C are as shown in Table 1 below. It is recommended to set a ratio of the glass and the oxide powder so that a linear expansion coefficient of the first coating layer 20 becomes close to the linear expansion coefficient all of the heat-sensitive body 11, based on these values. In addition, it is recommended to set a ratio of the glass and the oxide powder so that a linear expansion coefficient of the third coating layer 30 becomes close to the linear expansion coefficient α15 of the lead-out wire 15.

### Table 1

### Method for Manufacturing Temperature Sensor Element 1

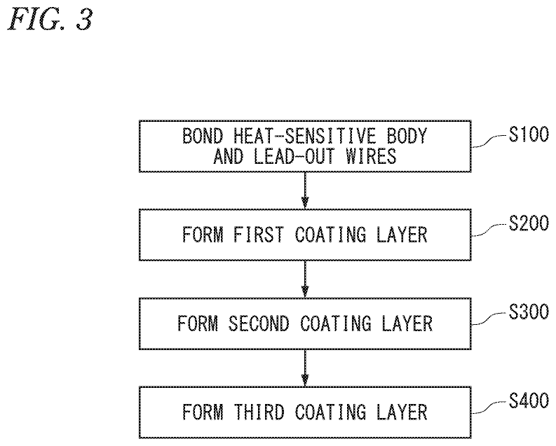

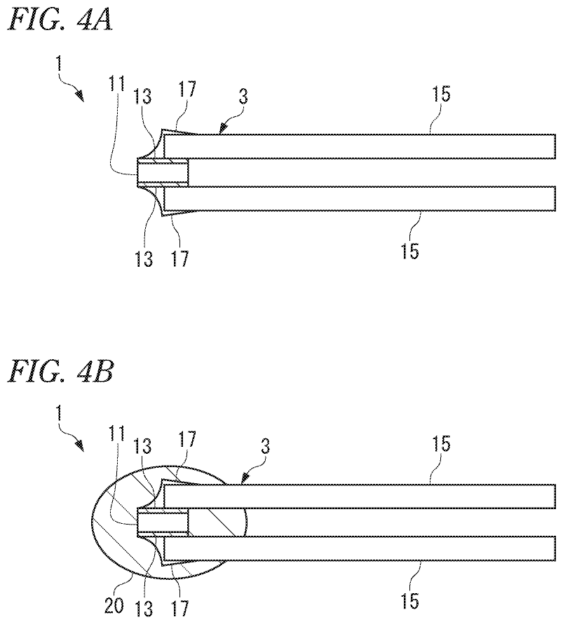

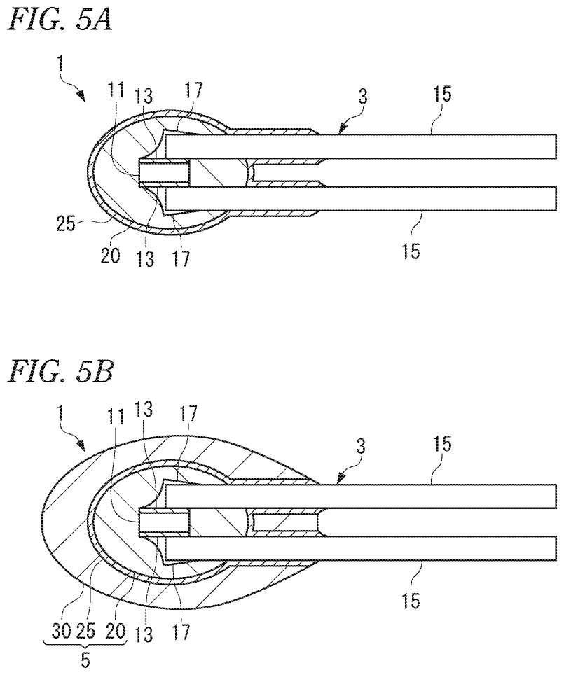

Next, a method for manufacturing the temperature sensor element 1 will be described with reference to FIG. 3, FIG. 4A, FIG. 4B, FIG. 5A and FIG. 5B

As shown in FIG. 3, the temperature sensor element 1 is manufactured through the steps of: bonding the heat-sensitive body 11 and the lead-out wires 15 and 15 (S100 in FIG. 3, and FIG. 4A) ; forming the first coating layer 20 on the bonded heat-sensitive body 11 (S200 in FIG. 3, and FIG. 4B); forming the second coating layer 25 on a periphery of the first coating layer 20 (S300 in FIG. 3, and FIG. 5A); and forming the third coating layer 30 over/on peripheries of the first coating layer 20 and the second coating layer 25 (S400 in FIG. 3, and FIG. 5B).

### Formation of First Coating Layer 20 (S200 in FIG. 3, and FIG. 4B)

For the first coating layer 20, a paste is prepared in which, for example, the previously described oxide powder, preferably, the thermistor powder and the crystallized glass powder are mixed with a solvent. The paste is applied to the surface of the heat-sensitive body 11, and then drying and firing treatment of the glass component are carried out to form the first coating layer 20.

For applying the paste to the surface of the heat-sensitive body 11, a dipping method is preferably employed in which the heat-sensitive body 11 and a predetermined range of the lead-out wire 15 are dipped in the paste and then pulled out from the paste. The same applies to the second coating layer 25 and the third coating layer 30.

When the first coating layer 20 is formed of a plurality of layers, dipping is performed a plurality of times, and then drying and firing treatment are carried out. In addition, when the first coating layer 20 is formed of a plurality of layers, a boundary between the adjacent coating layers can be visually recognized, but the adjacent coating layers are bonded to each other with a force of a degree that can secure the function of the first coating layer 20. This is also applied to the second coating layer 25 and the third coating layer 30 in the same manner.

### Formation of Second Coating Layer (S300 in FIG. 3, and FIG. 5A

For the second coating layer 25, a paste is prepared in which, for example, the oxide powder having a linear expansion coefficient as previously described larger than that of the oxide powder contained in the third coating layer 30, preferably, one or more types of powder of ZrO₂, CaO and MgO and the crystallized glass powder are mixed with a solvent. After the paste has been formed on the first coating layer 20, the resultant is dried, and the glass component is subjected to firing treatment; and thereby the second coating layer 25 is formed.

### Formation of Third Coating Layer (S400 in FIG. 3, and FIG. 5B)

Furthermore, as for the third coating layer 30 as well, the third coating layer 30 is formed on the second coating layer 25 with the use of the glass paste for the outer layer, which has been prepared by mixing of the oxide powder, the glass powder and the solvent in the same way as in the above description.

### Second Embodiment

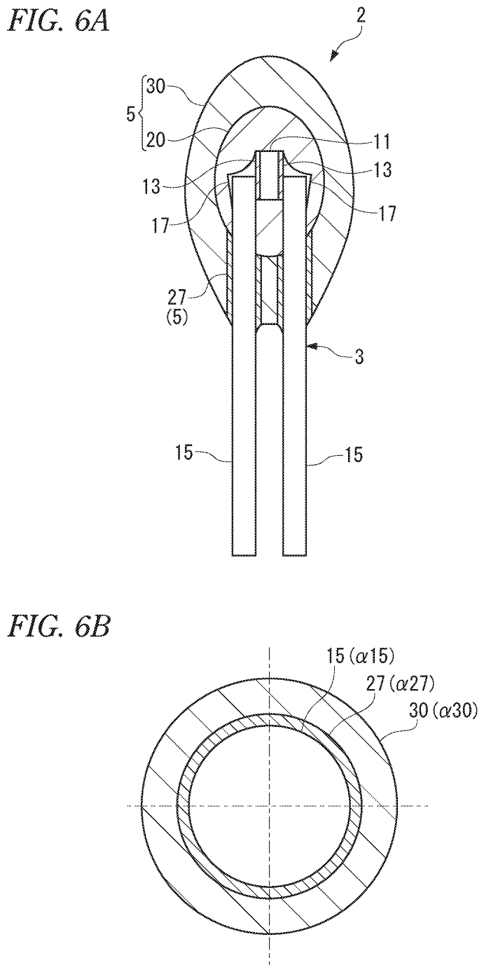

Next, a temperature sensor element 2 according to a second embodiment will be described with reference to FIGS. 6A and 6B.

When the temperature sensor element 2 is described in comparison with the temperature sensor element 1, the second coating layer 27 does not cover the first coating layer 20, and covers the periphery of the lead-out wires 15 and 15. In other words, in the temperature sensor element 2, the first coating layer 20 and the third coating layer 30 are in direct contact with each other, and the second coating layer 27 covers only the peripheries of the lead-out wires 15 and 15. Accordingly, the cross section of a portion at which the second coating layer 27 is provided has a structure in which the lead-out wire 15, the second coating layer 27 and the third coating layer 30 are arranged in this order from the inside or the center, similarly to that of FIG. 2A of the first embodiment.

The temperature sensor element 2 having the aforementioned cross-sectional structure around the lead-out wire 15 can enhance the reduction resistance, due to the compressive stress σ1 which is imparted to the lead-out wire 15 by the second coating layer 27, similarly to the temperature sensor element 1 of the first embodiment.

In addition, in the temperature sensor element 2, the first coating layer 20 and the third coating layer 30 are in direct contact with each other with no covering over the first coating layer 20, and the periphery of the third coating layer 30 is opened; and accordingly, there is no member that restrains the thermal expansion of the third coating layer 30. The relationship between the linear expansion coefficients α20 and α30 of the first coating layer 20 and the third coating layer 30 is as shown in the following Expression (2), and accordingly while the temperature sensor element 2 is used in a high temperature range, the first coating layer 20 and the heat-sensitive body 11 provided inside the first coating layer 20 do not receive the compressive stress σ2 from the third coating layer 30, theoretically.

α20<α30 Expression (2)

It is difficult to form the second coating layer 27 by dipping, but the second coating layer 27 can be formed by applying a paste to the region by means of a quantitative liquid discharge device that is called a dispenser, and then carrying out drying and firing treatment.

### First Example

Next, one example of the present invention will be described on the basis of specific Example.

The temperature sensor element 1 was manufactured that included the first coating layer 20, the second coating layer 25 and the third coating layer 30, which would be described below, and a rate of change in a resistance value was measured.

### Manufacture of Heat-Sensitive Body 11

Raw material powders having the following particle sizes (d50) were prepared the mixing ratios of which were controlled as shown in the following, and a heat-sensitive body 11 was manufactured according to the aforementioned steps. Calcination was performed under conditions of 1300 °C and 24 hours, and sintering was performed under conditions of 1500 °C and 24 hours, both in the air.
Y₂O₃: 79.5 mol %, particle size: 0.1 μm
Cr₂O₃: 8.5 mol %, particle size: 2.0 μm
CaCO₃: 3.5 mol %, particle size: 2.0 μm
Mn₃O₄: 8.5 mol %, particle size: 5.0 μm

The electrode 13, the lead-out wire 15 and the connection electrode 17 were all formed from platinum (Pt), and the thermistor element 3 was produced according to the procedure described in the embodiment.

### Formation of Coating Layers

On the thermistor element 3 described above, the first coating layer 20, the second coating layer 25 and the third coating layer 30 were formed.

For the first coating layer 20, crystalline glass was used as glass, and a thermistor powder was used which had the same composition as that of the heat-sensitive body 11. A mass ratio of the crystalline glass to the thermistor powder is 20:80. In addition, for a paste for the first coating layer 20, an organic binder was used as a binder, and one layer of a precursor layer was formed by dipping. After that, the precursor layer was dried and subjected to heat treatment for firing, and the first coating layer 20 according to the Example was formed. The linear expansion coefficient of the first coating layer 20 is represented by α20.

For the second coating layer 25, crystalline glass and oxide powders were used that were ZrO₂ powder, MgO powder and CaO powder. A mass ratio of the crystalline glass to the oxide powders (ZrO₂ powder, MgO powder, CaO powder) is 90:10. However, as for the MgO powder, a sample was also produced in which a mass ratio of the crystalline glass to the MgO powder was 80:20. The linear expansion coefficient of the second coating layer 25 is represented by α25.

For the third coating layer 30, crystalline glass and Y₂O₃ of the oxide powder were used. A mass ratio of the crystalline glass to the Y₂O₃ of the oxide powder is 80:20. The linear expansion coefficient of the third coating layer 30 is represented by α30.

Table 2 shows the linear expansion coefficients of the heat-sensitive body 11, the lead-out wire 15, the first coating layer 20, the second coating layer 25 and the third coating layer 30 which have been described above. In Table 2, the linear expansion coefficients of the first coating layer 20, the second coating layer 25 and the third coating layer 30 which were each a mixture of crystalline glass and an oxide powder were each calculated from a mass ratio (%) of the crystalline glass and the oxide powder.

Note that the thicknesses t25 of the second coating layer 25 and the thicknesses t30 of the third coating layer 30 are as follows.

t25=0.1 mm, and t30=0.6 mm

### Table 2

### First Example: First Measurement Condition

Rates of changes in electric resistance values were measured under the following conditions, with the use of four types of temperature sensor elements (Sample Nos. 1 to 4) shown in Table 3. The measurement results are shown in Table 3.
Holding temperature: 900 °C
Atmosphere: hydrogen 5 vol. %+nitrogen 95 vol. %
Holding time period: 10 hours
Resistance value measurement temperature: 25 °C

### Table 3

### First Example: Second Measurement Condition

A rate of change in the electric resistance value was measured under the second measurement conditions which were the same as the first measurement conditions except that the holding temperature was 1050 °C. The measurement results are shown in Table 4. Note that a sample was also produced in which the third coating layer 30 was formed directly on the first coating layer 20 without providing the second coating layer 25. The sample is denoted as sample No. 9 in Table 4, and the same applies to sample No. 16 in Table 5.

### Table 4

### First Example: Third Measurement Condition

Next, a rate of change in electrical resistivity was measured under the same conditions as the first measurement conditions, except that the electrical resistivity was measured after a cycle of raising the temperature from room temperature (25 °C) to 1050 °C and then lowering the temperature from 1050 °C to room temperature was repeated by 2000 cycles. The results are shown in Table 5.

### Table 5

### Second Example

Next, the Second Example will be described. In the Second Example, the first coating layer 20 was composed only of the thermistor powder having the same composition as the heat-sensitive body 11, without containing glass. The first coating layer 20 is obtained by dipping the heat-sensitive body 11 in a liquid mixture of the thermistor powder and an organic binder, and then volatilizing the solvent for drying. Then, a precursor of the first coating layer 20 is obtained in which the particles included in the first coating layer 20 are bound by the binder. After that, the second coating layer 25 and the third coating layer 30 are sequentially formed on/over the first coating layer 20 in the same way as in the First Example.

With the use of the samples obtained as described above, a rate of change in electrical resistivity was measured under each of the first measurement condition (held at 900 °C), the second measurement condition (held at 1050 °C) and the third measurement condition (cycle of room temperature to 1050 °C) in the First Example. The measurement results of the first measurement condition, the second measurement condition, and the third measurement condition are shown in Table 6, Table 7 and Table 8, respectively.

### Table 6

### Table 7

### Table 8

Note that in the measured values of the First Example and the Second Example, as for CaO, more preferable result was obtained in the case where the holding temperature was 1050 °C than in the case where the holding temperature was 900 °C. From this result, it can be said that CaO is preferable as the oxide powder in the second coating layer 25, in the case where the temperature sensor element is continuously used under a higher temperature atmosphere.

In the above, the preferable embodiments of the present invention have been described, but the configurations described in the aforementioned embodiments can be selected or replaced with other configurations, without departing from the gist of the present invention.

For example, in FIG. 1 and FIG. 5B, the ranges of the second coating layer 25 and the third coating layer 30 surrounding the lead-out wire 15 almost coincide with each other in the extending direction of the lead-out wire 15, but this is merely one preferable example. For example, as is shown by a dash-dotted line in FIG. 5B, the second coating layer 25 may protrude longer than the third coating layer 30. On the contrary, the third coating layer 30 may protrude longer than the second coating layer 25, though the illustration is omitted.

### REFERENCE SIGNS LIST

1, 2 temperature sensor element
3 thermistor element
5 coating layer
11 heat-sensitive body
13 electrode
15 lead-out wire
17 connection electrode
20 first coating layer
25, 27 second coating layer
30 third coating layer

1. A temperature sensor element comprising:
a heat-sensitive body having an electric resistance that is variable with temperature;
a first coating layer that covers a periphery of the heat-sensitive body;
a pair of lead-out wires that are connected to the heat-sensitive body and are led out in penetration through the first coating layer;
a second coating layer that covers peripheries of the pair of lead-out wires that are led out in penetration through the first coating layer; and
a third coating layer that covers peripheries of the first coating layer and the second coating layer, wherein
when linear expansion coefficients of the lead-out wire, the second coating layer and the third coating layer are represented by α15, α25 and α30, respectively,
a relationship of α15<α30<α25 holds.

2. The temperature sensor element according to claim 1, wherein
the first coating layer includes a first oxide powder or a mixture of the first oxide powder and glass,
the second coating layer includes a mixture of a second oxide powder and glass,
the third coating layer includes a mixture of a third oxide powder and glass, and
when the linear expansion coefficients of the first oxide powder, the second oxide powder and the third oxide powder are represented by β20, β25 and β30, respectively,
a relationship of β20<β30<β25 holds.

3. The temperature sensor element according to claim 2, wherein
the first oxide powder is formed of a thermistor powder as included in the heat-sensitive body, and
the second oxide powder is formed of one or more types of ZrO₂, CaO and MgO.

4. The temperature sensor element according to claim 1, wherein
the second coating layer covers peripheries of the pair of lead-out wires that are led out in penetration through the first coating layer, and also covers the first coating layer between the first coating layer and the third coating layer.

5. The temperature sensor element according to claim 1, wherein
the second coating layer limitedly covers the peripheries of the pair of lead-out wires that are led out in penetration through the first coating layer, and
the first coating layer and the third coating layer are in direct contact with each other.

6. The temperature sensor element according to claim 1, wherein
when a thickness of the second coating layer and a thickness of the third coating layer are represented by t25 and t30, respectively, a relationship of t25<t30 holds.

7. A temperature sensor comprising the temperature sensor element according to claim 1.
